(19) United States
(12) Patent Application Publication
(10) Pub. No.: US 2016/0016306 A1
(43) Pub. Date: Jan. 21, 2016

(54) APPARATUS, SYSTEM AND METHOD OF RETAINING HAND TOOLS

(71) Applicants: Scott HADDON, East Stroudsburg, PA (US); Lance Tesoroni, Saylorsburg, PA (US)

(72) Inventors: Scott HADDON, East Stroudsburg, PA (US); Lance Tesoroni, Saylorsburg, PA (US)

(21) Appl. No.: 14/726,415

(22) Filed: May 29, 2015

Related U.S. Application Data
(60) Provisional application No. 62/025,803, filed on Jul. 17, 2014.

(51) Int. Cl. B25H 3/04; F16B 1/00; F16B 2/22; B25H 5/00

(52) U.S. Cl. CPC B25H 3/04; B25H 5/00; F16B 1/00; F16B 2/22; F16B 2001/0035

(57) ABSTRACT

A retaining system embodying a method and apparatus for adjustably retaining hand tools in any position on a ferromagnetic surface, such as on the exterior of heavy equipment or in a truck bed is provided. The retaining system may embody an elongated channel member and a tool retainer. The tool retainer may include a pair of clip flanges extending generally perpendicular from a base. The pair of clip flanges may form a tension clip for securing handles of the hand tools within a receptive cavity. The base may provide a magnet for removably attaching to the ferromagnetic surface. Moreover, the base may provide interlocking projections along its periphery so that two or more tool retainer may be interlocked together when stacked one on top of another. Alternatively, the tool holders may be slidably secured within the channel member, when nearby attachment surfaces are made of non-ferromagnetic material.

### CROSS-REFERENCE TO RELATED APPLICATION

This application claims the benefit of priority of U.S. provisional application No. 62/025,803, filed 17 Jul. 2014, the contents of which are herein incorporated by reference.

### BACKGROUND OF THE INVENTION

The present invention relates to storage and, more particularly, to a system embodying a method and apparatus for adjustably retaining hand tools in any position on a ferromagnetic surface, whether that surface is disposed on the exterior of heavy equipment, around a job site, in a truck bed, in a truck cab, in a car trunk, in a garage, in or on a utility closet or the like.

There are no easy, adjustable ways to transport or organize hand tools and implements having elongated, round handles, such as shovels, rakes, and the like. Such hand tools stacked in a disorganized jumble in closets, garages, pickup beds, or on the ground are difficult to retrieve and are often damaged or lost. Moreover, such hand tools tend to slide around in the back of a truck or trunk of a car unless one installs a bulky, permanent and often damaging retaining device. In addition, transporting such hand tools inside heavy equipment is dangerous and difficult, yet there are no hand tool retaining devices operable for the exterior or interior of heavy equipment.

Current retaining devices for hauling, storing and organizing hand tools are attached with screws, tape, straps, or glue, and so are not adjustable and can't be removed easily. Furthermore, by being fixed in place, they take up limited cargo space and cannot be adjusted to suit the tool, job site or cargo hauling needs.

As can be seen, there is a need for a system embodying a method and apparatus for adjustably retaining hand tools in any position on a ferromagnetic surface, whether that surface is disposed on the exterior of heavy equipment, around a job site, in a truck bed, in a truck cab, in a car trunk, in a garage, in or on a utility closet or the like.

### SUMMARY OF THE INVENTION

In one aspect of the present invention, a tool retainer includes a base having a mounting face and an opposing flange face; a pair of clip flanges extending generally perpendicular from the flange face; and a magnet disposed along the mounting face.

In another aspect of the present invention tool retainer includes a base having a mounting face, wherein a magnet cavity is formed within the mounting face, and wherein a fastener hole is formed within the magnet cavity; an opposing flange face; a peripheral sidewall interconnecting the mounting face and the flange face; a first configuration of projections formed along a first portion of the peripheral sidewall, and wherein a mirror-image of the first configuration of projections are formed on an opposing second portion of the peripheral sidewall; and a female notch and a male bump formed amongst the first configuration of projections, wherein a complementary female notch and a complementary male bump are formed amongst the mirror-imaged projections of the second portion; a pair of clip flanges extending generally perpendicular from the flange face, wherein an arcuate portion is formed along each clip flange so as forming a receptive pocket between the two opposing arcuate portions, and wherein the pair of clip flanges terminate to define a slide-in void; and a magnet adapted and dimensioned to be received by the magnet cavity.

These and other features, aspects and advantages of the present invention will become better understood with reference to the following drawings, description and claims.

### BRIEF DESCRIPTION OF THE DRAWINGS

FIG. 1 is a front perspective view of an exemplary embodiment of the present invention;

FIG. 2 is a rear perspective view of an exemplary embodiment of the present invention;

FIG. 3 is an exploded view of an exemplary embodiment of the present invention;

FIG. 4 is an exploded view of an exemplary embodiment of the present invention, shown in use;

FIG. 5 is a perspective view of an exemplary embodiment of the present invention;

FIG. 6 is a perspective view of an exemplary embodiment of the present invention;

FIG. 7 is a perspective view of an exemplary embodiment of the present invention; and

FIG. 8 is a section detail view of an exemplary embodiment of the present invention, taken along line 8-8 in FIG. 7.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a retaining system embodying a method and apparatus for adjustably retaining hand tools in any position on a ferromagnetic surface, such as on the exterior of heavy equipment or in a truck bed. The retaining system may embody an elongated channel member and a tool retainer. The tool retainer may include a pair of clip flanges extending generally perpendicular from a base. The pair of clip flanges may form a tension clip for securing handles of the hand tools within a receptive cavity. The base may provide a magnet for removably attaching to the ferromagnetic surface. Moreover, the base may provide interlocking projections along its periphery so that two or more tool retainer may be interlocked together when stacked one on top of another. Alternatively, the tool holders may be slidably secured within the channel member, when nearby attachment surfaces are made of non-ferromagnetic material.

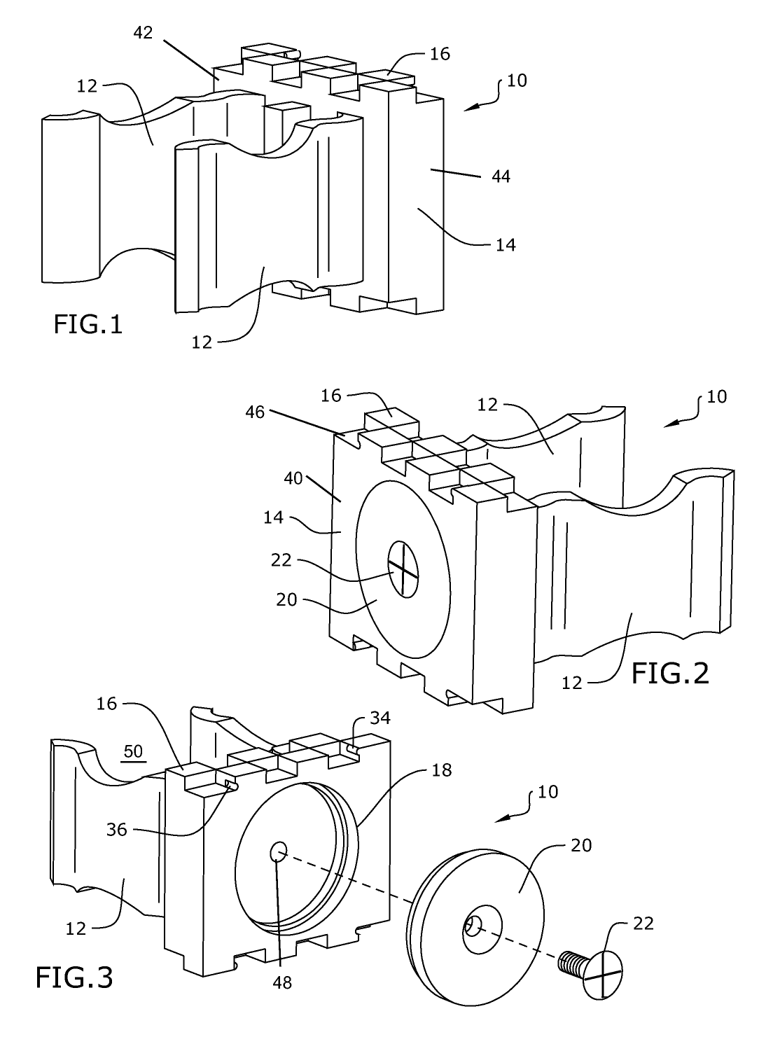

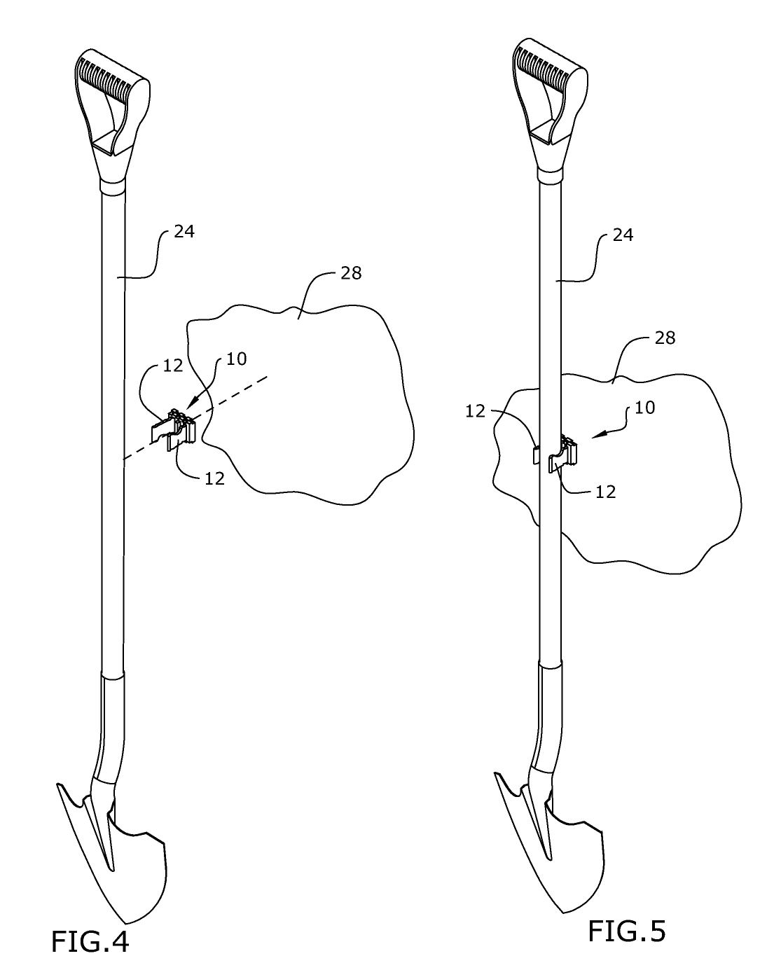

Referring to FIGS. 1 through 8, the present invention may include a retaining system for storing and organizing hand tools and implements having handles, such as shovels, rakes, and the like. The retaining system may embody an elongated channel member 30, at least one tool retainer 10 and a method of using them for storing and organizing the hand tools.

Each tool retainer 10 may include a pair of clip flanges 12 extending generally perpendicular from a base 14. The base 14 may form a generally rectangular cuboid having a mounting face 40 opposing a flange face 42, both of which are defined by a pair of opposing vertical walls 44 and a pair of opposing horizontal walls 46 along a periphery of the base 14.

A plurality of spaced-apart projections 16 may be formed along each horizontal wall 46, wherein the pattern of spaced-apart projections 16 on one horizontal wall 46 may be the mirror image of the pattern of spaced-apart projections 16 on the opposing horizontal wall 46, whereby two tool retainers 10, similarly oriented, with one horizontal wall 46 stacked on the other's (opposing) horizontal wall 46 would interlock their mirror-image patterns of spaced-apart projections 16. Such interlocking mating removably secures the two tool retainers 10 together so that they work in tandem about the same tool handle 24.

In certain embodiments, at least one projection 16 forms a female notch 36, while another at least one projection 16 forms a male bump 34 on the same horizontal wall 46, wherein projections 16 on the opposing horizontal wall 46 form a complementary male bump 34 and female notch 36 adapted and dimensioned to releasably mate with the opposing male bump 34 and female notch 36 during stacked interlocking.

The mounting face 40 may form a magnet cavity 18, generally centrally disposed therein, as illustrated in FIG. 3. Recessed within the magnet cavity 18 may be formed a fastener hole 48. The tool retainer 10 may include a magnet 20 secured within the magnet cavity 18. The magnet 20 may be secured thereto by a fastener 22 connected through a magnet hole and into the fastener hole 48. Each clip flange 12 may form a complementary arcuate portion as each extends from the flange face 42 so as they define a generally circular reception pocket 50. The pair of clip flanges 12 may terminate so as to define a slide-in void 52 in communication with the reception pocket 50. The reception pocket 50 may be adapted and dimensions to secure about rounded tool handles 24. Together the pair of clip flanges 12 form a tension clip positionable so that the slide-in void 52 expands in an open configuration to removably receive the tool handles 24 and then retract to their original configuration, removably securing the tool handles 24 within the reception pocket 50.

In certain embodiments, notches may be formed along an edge portion of each clip flange 12 for enabling smaller diameter tool handles to be held in place with self adhesive foam, zip ties, heavy rubber band or the like.

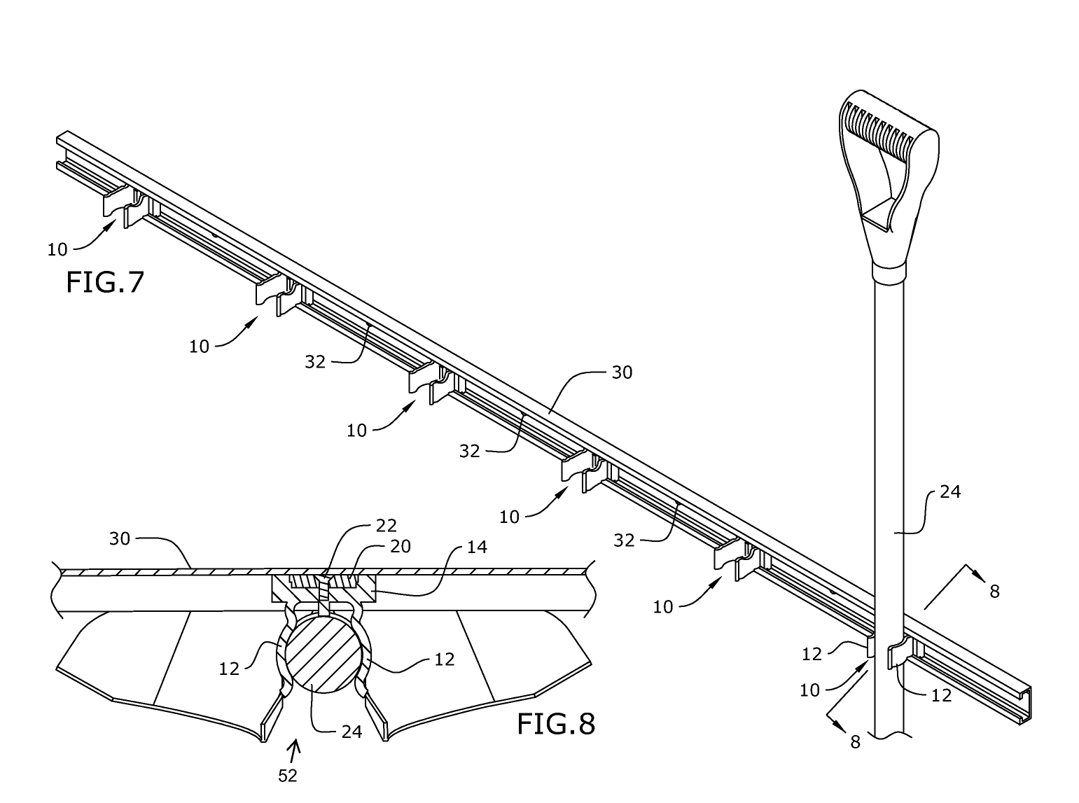

The retaining system may include the elongated channel member 30. The channel member 30 may be generally C-shaped so as to form a track dimensioned and adapted to slidably receive a plurality of tool retainers 10, operably engaging the opposing horizontal walls 46, as illustrated in FIGS. 7 and 8. Along a portion of the channel member 30 a plurality of track mounting holes 32 may be formed for securing the channel member 30 to an attachment surface using mechanical fasteners.

A method of using the present invention may include the following. A user may mount the mounting face 40 of the tool retainer 10 to a ferromagnetic attachment surface 28 via the magnet 20 so that the pair of clip flanges 12 extend therefrom. Then the user may removably secure the handle 24 of a hand tool within the receptive pocket 50 so as to store and/or organize at least one hand tool within the accompanying space.

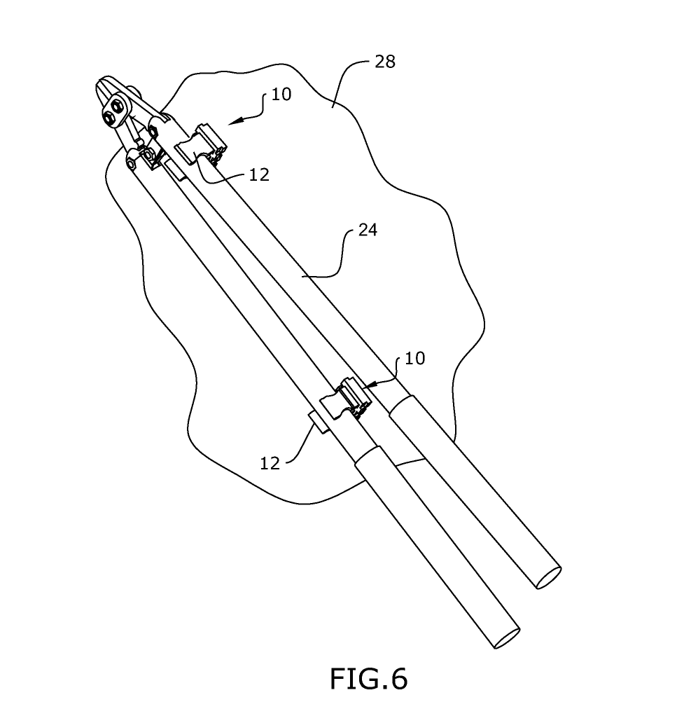

By attaching the tool retainer 10 to a shovel handle, rake, hoe or any round handled tool in two places the user can then place the tool on the inside lateral side of a pickup bed. The tool is now off the bed floor allowing room for cargo and easy access from the rear or side of the truck. Attaching the tool retainer 10 to a snow shovel or ice scraper carried in the trunk of a car allows the tool to be attached to the roof of the trunk leaving more room for other items. By attaching two or more tool retainers 10 to a hand tool with two handles 24 enables said hand tool to be removably connected to any ferromagnetic attachment surface 28 at each handle, so both are secured, as illustrated in FIG. 6.

In certain embodiments, the mounting face 40 may not house the magnet 20, but rather the user secures the mounting face 40 to a non-ferromagnetic attachment surface by attaching the fastener 22 through the fastener hole 48. In an alternative embodiment, the user fastens the channel member 30 the non-ferromagnetic attachment surface through its track mounting holes 32, and slidably populates the track with need tool retainers 10.

It should be understood, of course, that the foregoing relates to exemplary embodiments of the invention and that modifications may be made without departing from the spirit and scope of the invention as set forth in the following claims.

What is claimed is:

1. A tool retainer, comprising:
a base comprising:
a mounting face; and
an opposing flange face;
a pair of clip flanges extending generally perpendicular from the flange face; and
a magnet disposed along the mounting face.

2. The tool retainer of claim 1, further comprising a magnet cavity formed within the mounting face, wherein the magnet cavity is adapted and dimensioned to removably receive the magnet.

3. The tool retainer of claim 2, further comprising a fastener hole formed within the magnet cavity.

4. The tool retainer of claim 1, further compromising a peripheral sidewall interconnecting the mounting face and the flange face, wherein a first configuration of projections are formed along a first portion of the peripheral sidewall, and wherein a mirror-image of the first configuration of projections are formed on an opposing second portion of the peripheral sidewall.

5. The tool retainer of claim 4, further compromising a female notch and a male bump formed amongst the first configuration of projections, wherein a complementary female notch and a complementary male bump are formed amongst the mirror-imaged projections of the second portion.

6. The tool retainer of claim 1, further compromising an arcuate portion formed along each clip flange so as forming a receptive pocket between the two opposing arcuate portions.

7. The tool retainer of claim 1, wherein the pair of clip flanges terminate to define a slide-in void.

8. A tool retainer, comprising:
a base comprising:
a mounting face, wherein a magnet cavity is formed within the mounting face, and wherein a fastener hole is formed within the magnet cavity;
an opposing flange face;
a peripheral sidewall interconnecting the mounting face and the flange face;
a first configuration of projections formed along a first portion of the peripheral sidewall, and wherein a mirror-image of the first configuration of projections are formed on an opposing second portion of the peripheral sidewall; and
a female notch and a male bump formed amongst the first configuration of projections, wherein a complementary female notch and a complementary male bump are formed amongst the mirror-imaged projections of the second portion;
a pair of clip flanges extending generally perpendicular from the flange face, wherein an arcuate portion is formed along each clip flange so as forming a receptive pocket between the two opposing arcuate portions, and wherein the pair of clip flanges terminate to define a slide-in void; and
a magnet adapted and dimensioned to be received by the magnet cavity.

9. The tool retaining system, comprising:
the tool retainer of claim 4; and
an elongated channel member forming a track, wherein the track is dimensioned and adapted to slidably engage both the first portion of the peripheral sidewall and the second portion of the peripheral sidewall.
